(19) United States
(12) Patent Application Publication
(10) Pub. No.: US 2001/0045889 A1
(43) Pub. Date: Nov. 29, 2001

(54) Virtual sound system

(76) Inventor: James D. Hooberman, West Bloomfield, MI (US)

Correspondence Address: Avery N. Goldstein, Gifford, Krass, Groh, Sprinkle,, Anderson & Citkowski, P.C., 280 N. Old woodward Avenue, Suite 400, Birmingham, MI, 48009-5394, US

(21) Appl. No.: 09/780,177

(22) Filed: Feb. 9, 2001

Related U.S. Application Data
(60) Provisional application No. 60/181,647, filed on Feb. 10, 2000.

(51) Int. Cl. G08B 3/10

(52) U.S. Cl. 340/384.7

(57) ABSTRACT

A network-based program is provided for generating sleep inducing sounds at a user location. The program is accessed through a networked computer, web-based CRT, Palm Pilot, cellular telephone or pager. Alarm clock or visual components are also optionally provided.

### RELATED APPLICATION

This application claims priority of United States Provisional Patent Application 60/181,647 filed Feb. 10, 2000, and is incorporated herein by reference.

### FIELD OF THE INVENTION

The present invention relates to a network-based system generating sound masking external noises and selectively modifying system sound output. More particularly, the present invention generates sleep-inducing sounds on a timed basis and thereafter optionally operates as a virtual awaking device.

### BACKGROUND OF THE INVENTION

As television, the Internet and other forms of telecommunications merge into a vast worldwide interconnection, individuals find themselves in increasing contact with World Wide Web-based systems. With the advent of Web-based television, it is becoming increasingly common that individuals sleep in proximity to a computer or other Web access device.

In addition to the sound generated by an activated computer or other CRT device, background noise associated with a densely populated, twenty-four hour society means that sleeping in such an environment has become increasingly difficult.

### SUMMARY OF THE INVENTION

In order to promote sleep, the present invention operates through a networked computer, other Web-based CRT, Palm Pilot, cell phone or pager to produce sleep-inducing sounds. The sound generated by the present invention serves to mask background noise and induce relaxation.

### BRIEF DESCRIPTION OF THE DRAWINGS

FIG. 1 is a flow chart of an embodiment according to the present invention for virtual sound generation to induce sleep; and

FIG. 2 is a flow chart of another embodiment of the present invention operative in waking an individual.

### DETAILED DESCRIPTION OF THE PREFERRED EMBODIMENTS

The present invention has utility in generating sounds conducive to tranquility and/or sleep. The Web-based nature of the present invention provides a variety of sleep-inducing sounds to be accessed by a user. Further, the present invention is readily accessible by a traveler with Web access without the need to carry a sound-inducing appliance.

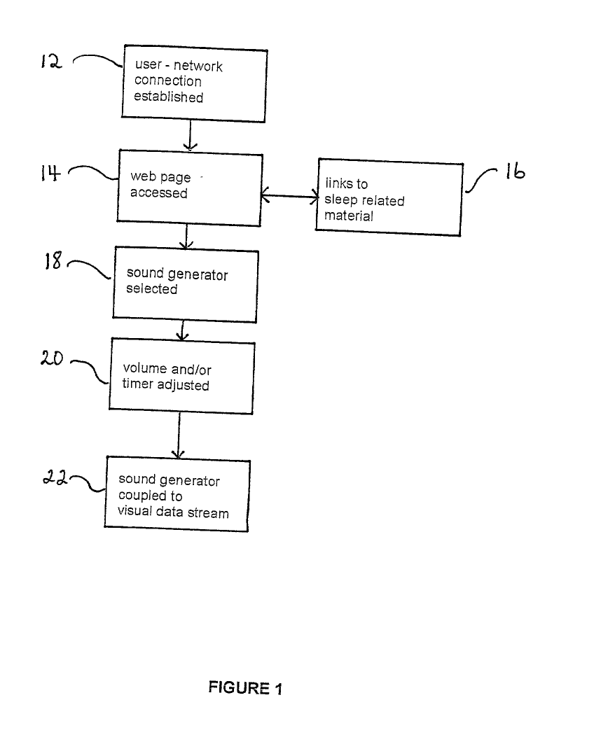

Referring to FIG. 1, a system for inducing sleep through virtual sound generation according to the present invention is shown. A user connection to the Internet 12 or other network is established. A user connection to the Internet is established directly or by way of a provider-based access network (not shown). The access network illustratively includes a telephone; cable television; a cellular device such as a Palm Pilot, cell phone or pager; or on-line service network, including, for example, CompuServe, America Online and the like. A user then accesses a Web page or set up screen associated with the present invention 14. A Web page according to the present invention prompts a user as to the necessary inputs for creating sleep-inducing sound. Optionally, the Web page of the present invention includes links 16 to sleep-related materials illustratively including products, advertisements, sleep-related research information and a chat room. The links 16 are intended to provide information about sleep disorders, products and techniques associated with inducing somnolence and interaction with other users in a similar situation. From the invention Web page, a user is prompted to select a desired sound generator 18. Sound modes available to a user include a repetitive oscillatory sound having a frequency of between 3 and 30 Hz. Oscillatory sounds in the frequency range given and preferably between 5 and 15 Hz are well known to induce relaxation and somnolence. Optionally, a volume control and timer are provided 20 to optimize the rhythmic effect and duration of the oscillatory sound. Additional relaxation inducing sounds according to the present invention illustratively include recorded or simulated sounds associated with a relaxing setting such as a beachfront, forest or pastoral setting. Alternatively, soothing musical forms illustratively including instrumentals, classical and rhythmic vocal music are also available to a user. The soundtrack selected by a user being accessed directly from the Web site or alternatively downloaded and stored on the user network access device memory. Optionally, after sampling the sound generator of the present invention, a user has a series of Web-based controls consistent with sound quality adjustment of the user Web access device speaker illustratively including treble, bass, surround sound and fade.

Optionally, the sound generator of the present invention is coupled with a visual stream incorporating patterns and/or colors modulated in concert with the output of the inventive sound generator 22. Thus, the virtual sound system of the present invention after user setup operates either with an inactive visual display or a visual stream modulated in concert with sound generator output.

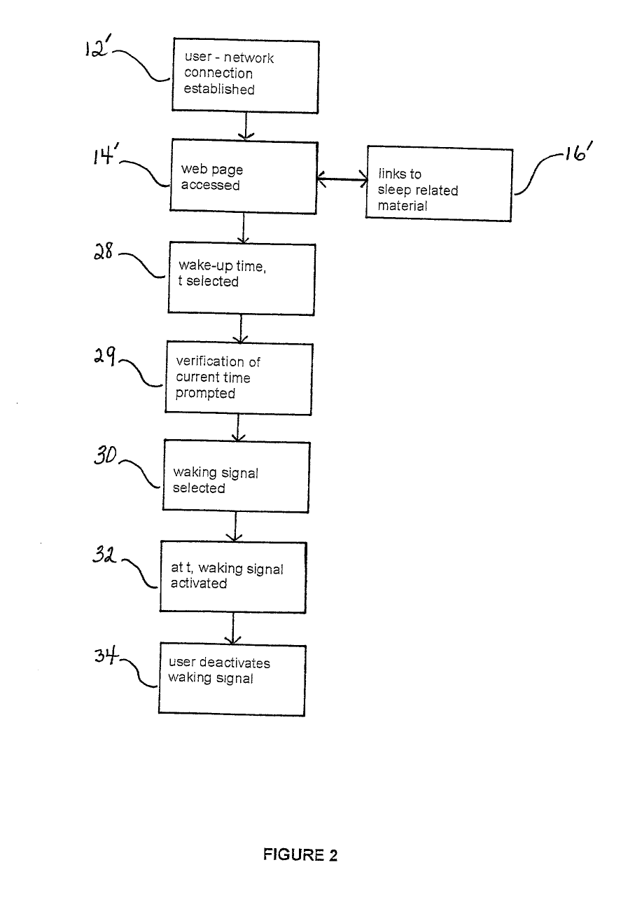

Another aspect of the present invention operative as an accessory to the embodiment depicted in FIG. 1 or alternatively as an independent embodiment is depicted in FIG. 2. A user connects to the network or Internet 12′. The user then accesses the inventive Web page 14′ which has links to sleep related subject matter 16′. Inventive steps 12′, 14′ and 16′ as described with reference to 12, 14 and 16, respectively. After a user has accessed the present invention and optionally investigated links to sleep-related subject matter 16′, a user inputs a desired wakeup time 28. In this embodiment of the present invention, a virtual alarm clock is provided. Following the user selecting a desired activation time (t) 28, an optional confirmatory prompt 29 is provided assuring that the user knows the current local time and a display thereof is constantly provided. Thereafter, the user selects a desired waking signal 30. The waking signal according to the present invention illustratively includes an auditory alarm sound, music, a television or radio broadcast, or a user preselected video which is played from a source illustratively including an on-line video, a cable TV channel, a DVD player or VCR. Thus, a user can preselect a video to awaken the user upon activation of the present invention. In instances where a user is awoken by music, the music is alternatively downloaded to the user network or Web access device or streamed directly from the Web site of the present invention. Television or radio broadcasts being accessed through a hyperlink selected by the user in advance of activation. Following user input in regard to wakeup time, mode of wakeup signal and the like, the virtual system of the present invention switches to a display energy saving mode having a blank visual display. Upon time lapse until activation time, the preselected waking signal is activated 32 and remains in the active state until disabled by an additional user input command 34. Optionally, the virtual alarm active state according to the present invention includes preselected “snooze” periods which promote a stepwise waking process. It is appreciated that an embodiment of the present invention for generating sleep-inducing sound is readily coupled with an alarm clock embodiment of the present invention to thereby promote sleep and assure waking at a desired time.

It is understood that the embodiments described herein are merely illustrative and not intended to limit the scope of the invention. It is appreciated that various changes, modifications and alterations will be readily apparent to one skilled in the art without departing from the spirit and scope of the present invention. These are intended to fall within the scope of the appended claims.

1. A virtual sound system comprising:
a network-based program for generating sleep inducing sounds at a user location.

2. The system of claim 1 wherein said sound has a frequency between 3 and 30 Hz.

3. The system of claim 1 wherein said program is linked to a Web site.

4. The system of claim 1 further comprising a sound controller selected from the group consisting of volume control and sound play duration.

5. The system of claim 1 further comprising a visual stream changing in concert with said sound.

6. The system of claim 1 further comprising an alarm clock routine.

7. A virtual sound system comprising:
a network-based program for creating an auditory alarm signal at a user location in response to an input of an activation time t.

8. The system of claim 6 wherein said auditory alarm signal is a television broadcast.

9. The system of claim 6 wherein said auditory alarm is a user preselected video.

10. The system of claim 9 wherein said video is an output of a source selected from a group consisting of: on-line video stream, DVD and VCR.
